(19) United States
(12) Patent Application Publication
(10) Pub. No.: US 2010/0319058 A1
(43) Pub. Date: Dec. 16, 2010

(54) METHOD USING ELECTRONIC CHIP FOR AUTHENTICATION AND CONFIGURING ONE TIME PASSWORD

(76) Inventor: Chia-Hong CHEN, Taipei (TW)

Correspondence Address: Muncy, Geissler, Olds & Lowe, PLLC, 4000 Legato Road, Suite 310, FAIRFAX, VA, 22033, US

(21) Appl. No.: 12/485,143

(22) Filed: Jun. 16, 2009

(51) Int. Cl. H04L 9/32

(52) U.S. Cl. 726/6; 726/9

(57) ABSTRACT

A method using an electronic chip for authentication and configuring an one time password uses a one time password generated at a one time password service end replacing a personal identification number required in authenticating operations on an electronic chip (IC cards, such as smart card, hardware secure module(HSM)e, EMV chip . . . etc.). Before operating on the electronic chip, a request for the one time password is sent to the one time password service end; or the one time password with access condition is applied in advance, and is used as a key to authenticate operations on the electronic chip. The method enhances privacy of the password and provides added application method for improved confidentiality.

### BACKGROUND OF THE INVENTION

1. Field of the Invention

The present invention is relates to a method for authentication with a password. More particularly, it relates to a method for authentication with a one time password.

2. Description of Prior Art

Digital products have played major roles in everyday life due to the rapid development of technology. Accordingly, it has become a norm to storage user privacy data in digital products.

In recent years, electronic chips for holder identification are frequently used in everyday life. Derived products in the market include an Auto Teller Machine Integrated Circuit card (referred as ATM IC card in the following), a mobile phone Subscriber Identity Module card (referred as SIM card in the following) and an access card, which are useful to reduce potential inconveniences caused to users via executing user identification directly.

The ATM IC card with an electronic chip is the representative application of products with identification electronic chips. In fact, the ATM IC card has replaced traditional means for cash withdrawal by carrying deposit books and withdrawal slips to the bank counter. Users make cash withdrawal simply by an ATM IC card and a Personal Identification Number (referred as PIN in the following) for authentication. Even in the working after hours, users make withdrawal within regulated limit via ATM. The use of ATM IC cards has brought conveniences to users.

Another implementation is a mobile SIM card. A user purchases to a SIM card representing caller identity and a PIN for SIM card authentication, the caller is free to make calls by putting the SIM card in any mobile phone and the receiver identify the caller identity by the unique caller number identified via the SIM card.

Nonetheless, IC cards are used for user identification and further protected by a PIN only disclosed to each card user. The fast development of network technology also lead to wide spread of hackers and viruses, confidential data and PINs of electronic ships used by computer users saved in computers are stolen as a result. Users may worry that the users' identity is at risk of being stolen and individual interests may be violated. Further, given the fact that a PIN is configurable by users, generally users use the same PIN for various IC cards and do not update the PIN periodically due to convenience concern or highly lack of sense of information security. Once the IC card and the PIN are stolen, it often leads to severe loss.

Using a fixed PIN for authentication has low safety level and is at high risk of being stolen and abused. Consequently, a new method of one time password (referred as OTP in the following) for identity authentication is devised to address to the risks.

FIG. 1 is a block diagram of authentication method with an OTP implemented by an OTP client end 11 and an OTP service end 13. The client end 11 registers with the service end 13 before authenticating with an OTP. The file folder 133 of the client end 11 is saved in a backend database 131 of the service end 13. The file folder 133 of the client end 11 includes algorithms (11a, 13a) negotiated by the OTP service end 13 and the client end 11 and identical secret keys (11c, 13c) in addition to basic personal data.

FIG. 2 is a flow chart of authentication method with an OTP. When the client end 11 starts identity authentication, the algorithm 11a and the public key 11c in a database 111 of the client end 11 are used to generate an OTP (step S20), and transmit the OTP and the basic data of the client end 11 to the OTP service end 13 for making a request to perform identity authentication (step S22). When the OTP service end 13 receives the request to perform identity authentication from the client end 11, the OTP service end 13 verify if the data folder 133 of the client end 11 saved in the backend database 131 of the OTP service end 13. In other words, the OTP service end 13 verify if there is a record showing that the client end 11 registered with the service end 13 (S24). If the client end 11 has registered and the file folder 133 of the client end 11 is saved in the backend database 131, the algorithm 13a and the public key 13c saved in the client end 11 are retrieved and generate an OTP via calculation with the algorithm 13a and the public key 13c and requesting condition (step S26).

In the end, the OTP calculated by the service end 13 is examined if the OTP coincides with the OTP transmitted from the client end 11 (step S28). If two OTPs coincide, the identity of the client end is authenticated. The authentication result is returned to the client end 11 which made the request (step S2a).

Nonetheless, the authentication method is effective in performing user identification and is restricted in serving as personal identification password in various digital products. The security level is high yet the application fields are limited. It is therefore a need to devise a method to broaden the application fields of the authentication method.

### SUMMARY OF THE INVENTION

The object of the present invention is to provide a method using an electronic chip for authentication and configuring a one time password (OTP) uses a one time password generated at a one time password service end replacing a personal identification number required in authenticating operations on an electronic chip. The method uses different OTP for authentication every single time and uses access conditions to control OTP generation.

The above mentioned object is realized by using OTP generated by OTP service replacing a personal identification number (PIN) time code via calculation, Before operating on an electronic chip, a request for an one time password is transmitted to an one time password service end; or the one time password authentication with access condition is applied in advance and is used as a key to authenticate operations on the electronic chip.

The method enhances privacy of the password and provides added application method and improves confidentiality.

### DETAILED DESCRIPTION OF THE INVENTION

In cooperation with attached drawings, the technical contents and detailed description of the present invention are described thereinafter according to a preferable embodiment.

FIG. 3 is a block diagram of a method using an electronic chip for authentication and configuring according to the present invention. According to FIG. 3, the method of present invention is implemented via service provider 31 of a one time password (referred as OTP in the following) and an electronic chip 35. The electronic chip 35 includes an OTP verification unit 351, a private storage unit 353 and a public storage unit 355. Generally, corresponding objects private keys 3531, 3551 and public keys 3533, 3553 are saved in two storage units 353, 355. It should be noted that implementation is not limited by the above embodiment. People skilled in the art are acknowledged that the storage units are subject to configuration depending on the requirements. A private unit is accessible via a PIN or the OTP authentication according to the present invention. A public storage unit is accessible via having the drivers from an electronic chip installed without authentication without protecting means. The electronic chip 35 may not necessarily include a private storage unit 353 and a public storage unit 355, which is not a limitation of the present invention. The following details the embodiment deploying the private storage unit 353.

The present invention utilizes a OTP 33 authorized by the OTP service provider 31 as the Personal Identification Number (referred as PIN in the following) required for the authentication of the electronic chip 35 such that users get access to the storage unit 353 upon authentication and retrieve the private key 3531 or the public key 3533 in the storage unit 353. Before a user operate on the electronic chip 35, a PIN of the electronic chip 35 is required for authentication. Accordingly, the user transmits a request for OTP 33 to the OTP service provider 31 for proceeding to authentication. The verification unit 351 of the electronic chip 35 is used for verifying if the OTP 33 is valid and authorized by the OTP service provider 31. Upon the verification unit 351 verifying the OTP 33 in use is valid, then the authentication is effective. The user proceed to retrieving the private key 3531 or the public key 3533 saved in the storage unit 353 of the electronic chip 35 for performing following operations such as signature, withdrawal. However, in contrast with the private storage unit 353, a user is allow to retrieve the private key 3551 or the public key 3553 in the public storage unit 355 upon installing a driver from the electronic chip 35. Alternatively, a user is allowed to retrieve the private key 3551 or the public key 3553 saved in the public storage unit 355 following about mentioned OTP authentication means. In other words, the public storage unit 355 is defined as another private storage unit 353 in the alternative embodiment mentioned. The preferred embodiment detailed above is subject to change according to the application requirements and is not limited to the above configurations.

FIG. 4 is a flow chart of a method using an electronic chip for authentication and configuring according to the present invention. First, an user makes a request for an OTP 33 to the OTP service provider 31 before the user operate on a digital product having the electronic chip 35 such as making a withdrawal with an ATM IC card (step S40). Following that, the OTP service provider 31 verifies the identity of the user made the request, confirms the user is qualified to make the request, then randomly generates an OTP 33 via calculation and authorizes the OTP 33 to the user (step S42).

When the user receives the OTP 33 authorized by the OTP service provider 31, the OTP33 is used to replace the PIN of the electronic chip 35 (step S44), and proceeds to the authentication of the electronic chip 35 (step S46). If the OTP 33 requested is wrong, then the authentication performed in the OTP verification unit 351 of the electronic chip 35 fails. The user is required to make the request for another OTP 33 to the OTP service provider 31 for performing another authentication. The OTP verification unit 351 verifies if the OTP 33 satisfies the access conditions negotiated by two ends upon requested OTP 33 pass the authentication performed in the OTP verification unit 351 (step S48).

It should be noted that a normal user is only allowed to access to the data in the electronic chip 35, initialization and management of the electronic chip 35 is performed by a security officer (Security Officer, SO). The SO is assigned to the following management tasks:

1. configuring the electronic chip 35 to apply a PIN or an OTP of present invention replacing the PIN for performing authentication. When the electronic chip 35 is not configured to use an OTP replacing a PIN, the electronic chip 35 performs authentication via a PIN;

2. configuring the storage units 353, 355 as public or private sections in the electronic chip 35, which are accessible via passing authentication with an OTP or a PIN;

3. performing algorithm mechanism required in the method for OTP authentication of the present invention.

The algorithm mechanism mentioned above refers to the access conditions of an OTP including time limitations, count limitations and event limitations. The electronic chip 35 is configured to install OTP verification units 351 to perform different authentication according to the access conditions negotiated by two ends. Or adding an identity code for differentiating access conditions (for example A123456, wherein A represents time limitation) to an OTP by re-configure the OTP calculation. The time limitation of an OTP refers to that the OTP is only valid within the specific period (for example an OTP is valid for 30 seconds, or configuring starting time and ending time of valid period of an OTP authentication). The count limitation of an OTP refers to that an OTP is permitted for authentication by limited counts (for example, the OTP is valid upon the permitted authentication count is higher than zero, or upon permitted authentication count is between three and ten). The event limitation of an OTP refers to that an OTP is valid upon particular events are triggered (for example, a ATM IC card is valid only in particular areas or a mobile phone SIM card is allowed to make specific calls). The above examples are used to details preferred embodiments of the present invention and are not used to limit the scope of the present invention.

As mentioned above, when the OTP verification unit 351 verifies if the OTP 33 satisfies the access conditions (step S4a), the user is allowed to access the private storage unit 353 or the public storage unit 355 in the electronic chip 35 and retrieve the private keys 3531, 3551 or the public keys 3533, 3553 in the storage units 353, 355 (step S4c) to perform confidential operations such as digital signature, make a withdrawal.

In addition to above mentioned embodiments to make request for an OTP for authentication from a client end to an OTP service providing end, an alternative embodiment is provided as shown in FIG. 5. Upon the client end registers with the OTP service providing end 31 according to the protocol, the OTP service providing end 31 introduces and saves the personal data, algorithm and public key of the client end in an independent hardware or software to form an OTP generator 5. At the same time, the generation conditions (i.e. time limitations, count limitations and event limitations mentioned above) are also configured into the OPT generator 5. The client end retrieves the OTP generator 5 from the OTP service providing end. The OTP generator 5 is triggered (for example pressing a button on the OTP generator 5) upon situations where generation conditions are satisfied in order to receive an OTP33 as the PIN required proceeding to authenticating the electronic chip 35. Such alternative embodiment is another preferred embodiment of the present invention and should not limit the scope of the present invention.

As the skilled person will appreciate, various changes and modifications can be made to the described embodiments. It is intended to include all such variations, modifications and equivalents which fall within the scope of the invention, as defined in the accompanying claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a block diagram of authentication method with One Time Password (OTP);

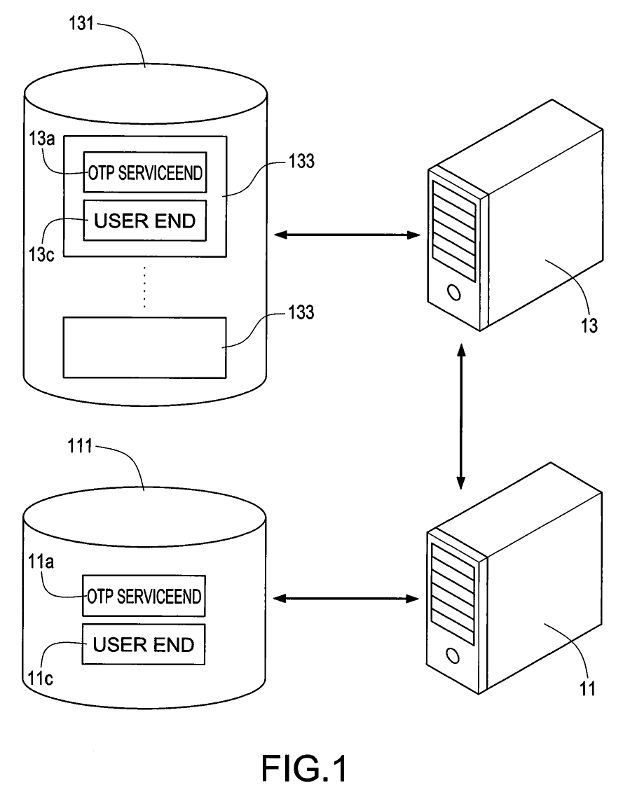

FIG. 2 is a flow chart of authentication method with an OTP;

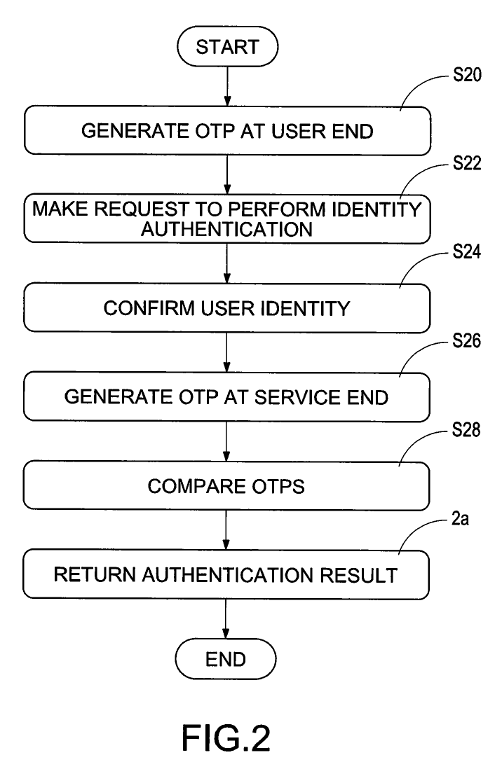

FIG. 3 is a block diagram of a method using an electronic chip for authentication and configuring according to the present invention; and

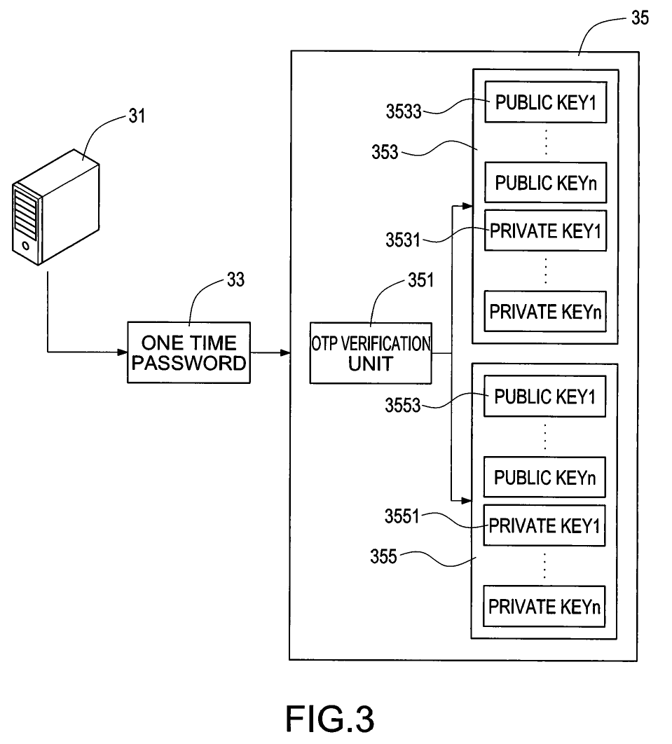

FIG. 4 is a flow chart of a method using an electronic chip for authentication and configuring according to the present invention.

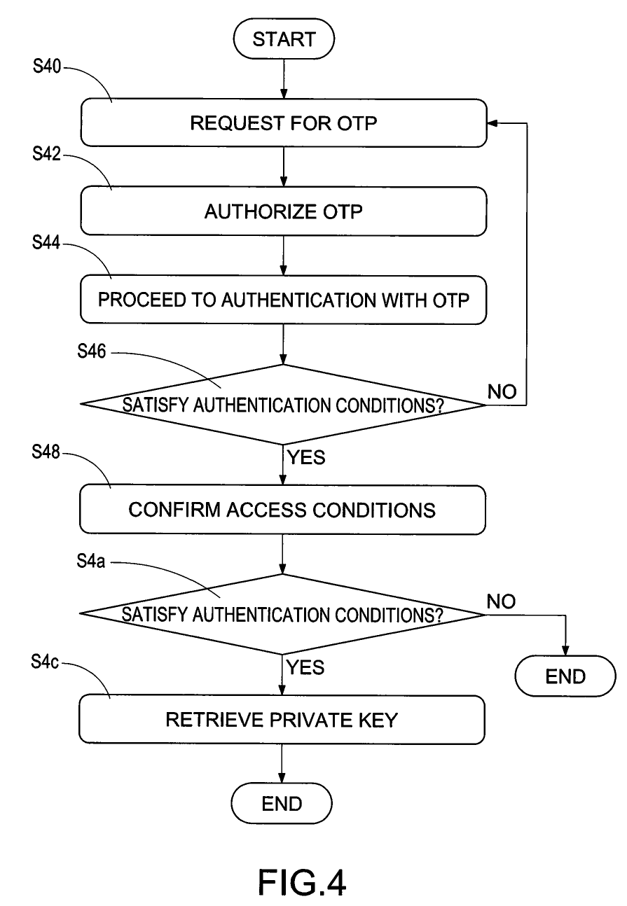

FIG. 5 is a block diagram of a method using an electronic chip for authentication and configuring according to another preferred embodiment of the present invention.

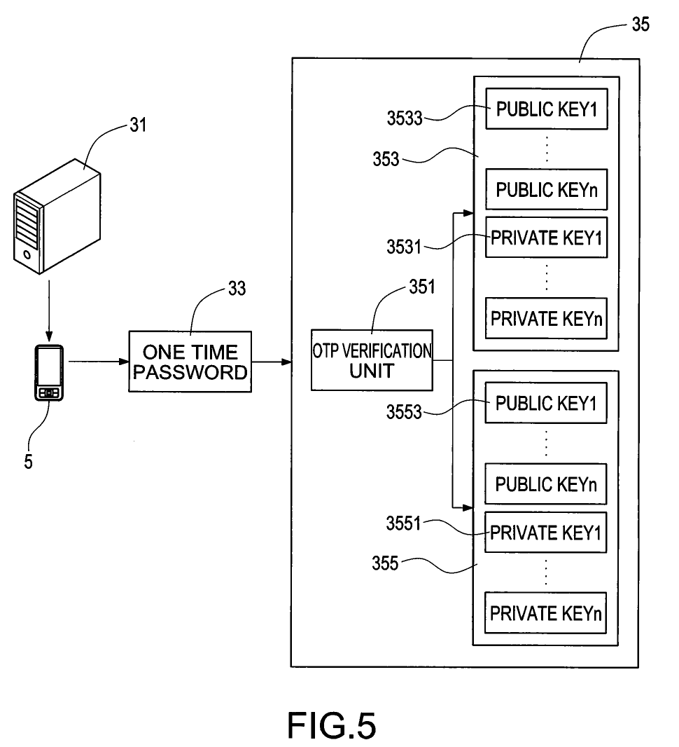

What is claimed is:

1. A method using an electronic chip for authentication and configuring a one time password, a client end registering in a one time password service end as a member in advance, comprising:
a) making a request to said one time password service end;
b) verifying if a registration record existed;
c) authorizing a one time password upon verifying the registration record existed at step b;
d) authenticating said electronic chip with said one time password;
e) examining if access conditions of said one time password are satisfied; and
f) operating on said electronic chip upon said access conditions of said one time password are satisfied following step e.

2. The method of claim 1, wherein said authentication with said one time password is performed in a one time password verification unit of said electronic chip at step d.

3. The method of claim 1, wherein said access conditions are configured by a Security Officer (SO) at step e.

4. The method of claim 3, wherein said access conditions comprises performing said authentication with said one time password within time limitation at step e.

5. The method of claim 3, wherein access conditions comprises performing said authentication with said one time password upon particular events are triggered at step e.

6. The method of claim 3, wherein said access conditions comprises uses said one time password when upon permitted authentication count is higher than zero at step e.

7. The method of claim 1, wherein examine uses a private key or a public key stored in a private storage unit of said electronic chip upon access conditions of said one time password are satisfied at step f.

8. The method of claim 1, wherein examine uses a private key or a public key stored in a public storage unit of said electronic chip upon access conditions of said one time password are satisfied at step f.

9. A method using an electronic chip for authentication and configuring a one time password, a client end registering in an one time password service end as a member in advance to generate a one time password protocol and to form a one time password generator, comprising:
a) triggering said one time password generator to generate a one time password;
b) authenticating an electronic chip with said one time password;
c) examining if access conditions of said one time password are satisfied following step b; and
d) operating on said electronic chip upon said access conditions of said one time password are satisfied following step c.

10. The method of claim 9, wherein said one time password generator is triggered to generate said one time password upon said OTP generation protocol is satisfied at step a.

11. The method of claim 9, wherein said authentication with said one time password is performed in a one time password verification unit in said electronic chip at step b.

12. The method of claim 9, wherein said access conditions are configured by a Security Officer (SO) at step c.

13. The method of claim 12, wherein said access conditions comprises performing said authentication with said one time password within time limitation at step c.

14. The method of claim 12, wherein access conditions comprises performing said authentication with said one time password upon particular events are triggered at step c.

15. The method of claim 12, wherein said access conditions comprises uses said one time password when upon permitted authentication count is higher than zero at step c.

16. The method of claim 9, wherein examine uses a private key or a public key stored in a private storage unit of said electronic chip upon access conditions of said one time password are satisfied at step d.

17. The method of claim 9, wherein examine uses a private key or a public key stored in a public storage unit of said electronic chip upon access conditions of said one time password are satisfied at step d.
